(19) United States
(12) Patent Application Publication
(10) Pub. No.: US 2021/0255861 A1
(43) Pub. Date: Aug. 19, 2021

(54) ARITHMETIC LOGIC UNIT

(71) Applicant: Micron Technology, Inc., Boise, ID (US)

(72) Inventors: Vijay S. Ramesh, Boise, ID (US); Allan Porterfield, Durham, NC (US); Richard C. Murphy, Boise, ID (US)

(21) Appl. No.: 17/143,652

(22) Filed: Jan. 7, 2021

Related U.S. Application Data
(60) Provisional application No. 62/971,480, filed on Feb. 7, 2020.

(51) Int. Cl. G06F 9/30; G06F 9/38; G06F 7/57; G06K 9/62; G06N 3/04

(52) U.S. Cl. CPC G06F 9/30036; G06F 9/30079; G06N 3/04; G06F 7/57; G06K 9/6256; G06F 9/3895

(57) ABSTRACT

Systems, apparatuses, and methods related to arithmetic logic circuitry are described. A method utilizing such arithmetic logic circuitry can include performing, using a processing device, a first operation using one or more vectors formatted in a posit format. The one or more vectors can be provided to the processing device in a pipelined manner. The method can include performing, by executing instructions stored by a memory resource, a second operation using at least one of the one or more vectors and outputting, after a fixed quantity of time, a result of the first operation, the second operation, or both.

### PRIORITY INFORMATION

This application claims priority to U.S. Provisional application Ser. No. 62/971,480 filed on Feb. 7, 2019, the contents of which are incorporated herein by reference.

### TECHNICAL FIELD

The present disclosure relates generally to semiconductor memory and methods, and more particularly, to apparatuses, systems, and methods relating to an arithmetic logic unit.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 is a functional block diagram in the form of a computing system including an apparatus including a host and a memory device in accordance with a number of embodiments of the present disclosure.

FIG. 2A is a functional block diagram in the form of a computing system including an apparatus including a host and a memory device in accordance with a number of embodiments of the present disclosure

FIG. 2B is a functional block diagram in the form of a computing system including a host, a memory device, an application-specific integrated circuit, and a field programmable gate array in accordance with a number of embodiments of the present disclosure.

FIG. 3 is an example of an n-bit post with es exponent bits.

FIG. 4A is an example of positive values for a 3-bit posit.

FIG. 4B is an example of posit construction using two exponent bits.

FIG. 5 is a functional block diagram in the form of an arithmetic logic unit in accordance with a number of embodiments of the present disclosure.

FIG. 6 is a functional block diagram in the form of a portion of an arithmetic logic unit in accordance with a number of embodiments of the present disclosure.

FIG. 7 illustrates an example method for an arithmetic logic unit in accordance with a number of embodiments of the present disclosure.

### DETAILED DESCRIPTION

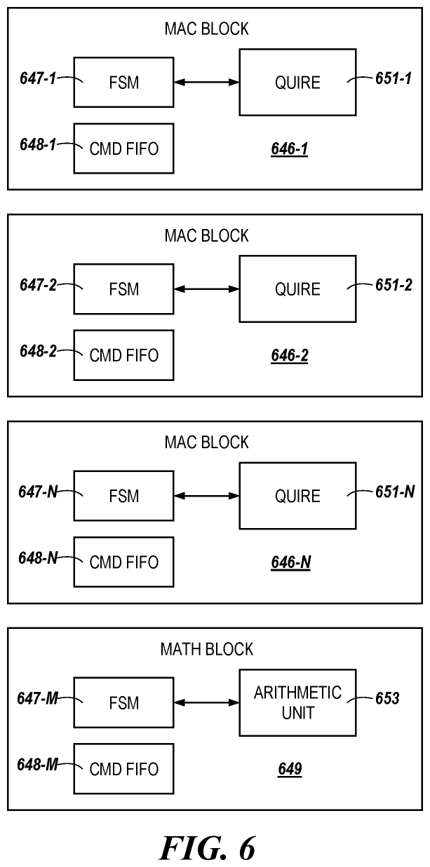

Posits, which are described in more detail, herein, can provide greater precision with the same number of bits or the same precision with fewer bits as compared to numerical formats such as floating-point or fixed-point binary. The performance of some machine learning algorithms can be limited not by the precision of the answer but by data bandwidth capacity of an interface used to provided data to the processor. This may be true for many of the special purpose inference and training engines being designed by various companies and startups. Accordingly, the use of posits could increase performance, particularly on floating-point codes that are memory bound. Embodiments herein include a FPGA full posit arithmetic logic unit (ALU) that handles multiple data sizes (e.g., 8-bit, 16-bit, 32-bit, 64-bit, etc.) and exponent sizes (e.g., exponent sizes of 0, 1, 2, 3, 4, etc.). One feature of the posit ALU described herein is the quire (e.g., the quire 651-1, . . . , 651-N illustrated in FIG. 6, herein), which can eliminate or reduce rounding by providing for extra result bits. Some embodiments can support a 4 Kb quire for data sizes up to 64-bits with 4 exponent bits (e.g., <64,4>). In some embodiments, the entire ALU can include less than 77K gates; however, embodiments are not so limited and embodiments in which the entire ALU can include greater than 77K (e.g., 145K gates, etc.) are contemplated as well. Because of latencies involved using a FPGA ALU, a pipelined vector can be implemented to reduce the number of startup delays. A simplified posit basic linear algebra subprogram (BLAS) interface that can allow for posits applications to be executed is also contemplated. In some embodiments, tensor flow using posits can allow for an evaluation application that uses MobileNet to identify both pre-trained and retrained networks. Some examples described herein include test results for a small collection of objects in which posit, Bfloat16, and Float16 confidence were examined. In addition, DOE mini-applications or “mini-apps,” can be ported to the posit hardware and compared with the IEEE results.

Computing systems may perform a wide range of operations that can include various calculations, which can require differing degrees of accuracy. However, computing systems have a finite amount of memory in which to store operands on which calculations are to be performed. In order to facilitate performance of operation on operands stored by a computing system within the constraints imposed by finite memory resources, operands can be stored in particular formats. One such format is referred to as the “floating-point” format, or “float,” for simplicity (e.g., the IEEE 754 floating-point format).

Under the floating-point standard, bit strings (e.g., strings of bits that can represent a number), such as binary number strings, are represented in terms of three sets of integers or sets of bits—a set of bits referred to as a “base,” a set of bits referred to as an “exponent,” and a set of bits referred to as a “mantissa” (or significand). The sets of integers or bits that define the format in which a binary number string is stored may be referred to herein as an “numeric format,” or “format,” for simplicity. For example, the three sets of integers of bits described above (e.g., the base, exponent, and mantissa) that define a floating-point bit string may be referred to as a format (e.g., a first format). As described in more detail below, a posit bit string may include four sets of integers or sets of bits (e.g., a sign, a regime, an exponent, and a mantissa), which may also be referred to as a “numeric format,” or “format,” (e.g., a second format). In addition, under the floating-point standard, two infinities (e.g., +∞ and −∞) and/or two kinds of “NaN” (not-a-number): a quiet NaN and a signaling NaN, may be included in a bit string.

The floating-point standard has been used in computing systems for a number of years and defines arithmetic formats, interchange formats, rounding rules, operations, and exception handling for computation carried out by many computing systems. Arithmetic formats can include binary and/or decimal floating-point data, which can include finite numbers, infinities, and/or special NaN values. Interchange formats can include encodings (e.g., bit strings) that may be used to exchange floating-point data. Rounding rules can include a set of properties that may be satisfied when rounding numbers during arithmetic operations and/or conversion operations. Floating-point operations can include arithmetic operations and/or other computational operations such as trigonometric functions. Exception handling can include indications of exceptional conditions, such as division by zero, overflows, etc.

An alternative format to floating-point is referred to as a “universal number” (unum) format. There are several forms of unum formats—Type I unums, Type II unums, and Type III unums, which can be referred to as “posits” and/or “valids.” Type I unums are a superset of the IEEE 754 standard floating-point format that use a “ubit” at the end of the mantissa to indicate whether a real number is an exact float, or if it lies in the interval between adjacent floats. The sign, exponent, and mantissa bits in a Type I unum take their definition from the IEEE 754 floating-point format, however, the length of the exponent and mantissa fields of Type I unums can vary dramatically, from a single bit to a maximum user-definable length. By taking the sign, exponent, and mantissa bits from the IEEE 754 standard floating-point format, Type I unums can behave similar to floating-point numbers, however, the variable bit length exhibited in the exponent and fraction bits of the Type I unum can require additional management in comparison to floats.

Type II unums are generally incompatible with floats, however, Type II unums can permit a clean, mathematical design based on projected real numbers. A Type II unum can include n bits and can be described in terms of a “u-lattice” in which quadrants of a circular projection are populated with an ordered set of 2n⁻³−1 real numbers. The values of the Type II unum can be reflected about an axis bisecting the circular projection such that positive values lie in an upper right quadrant of the circular projection, while their negative counterparts lie in an upper left quadrant of the circular projection. The lower half of the circular projection representing a Type II unum can include reciprocals of the values that lie in the upper half of the circular projection. Type II unums generally rely on a look-up table for most operations. As a result, the size of the look-up table can limit the efficacy of Type II unums in some circumstances. However, Type II unums can provide improved computational functionality in comparison with floats under some conditions.

The Type III unum format is referred to herein as a “posit format” or, for simplicity, a “posit.” In contrast to floating-point bit strings, posits can, under certain conditions, allow for higher precision (e.g., a broader dynamic range, higher resolution, and/or higher accuracy) than floating-point numbers with the same bit width. This can allow for operations performed by a computing system to be performed at a higher rate (e.g., faster) when using posits than with floating-point numbers, which, in turn, can improve the performance of the computing system by, for example, reducing a number of clock cycles used in performing operations thereby reducing processing time and/or power consumed in performing such operations. In addition, the use of posits in computing systems can allow for higher accuracy and/or precision in computations than floating-point numbers, which can further improve the functioning of a computing system in comparison to some approaches (e.g., approaches which rely upon floating-point format bit strings).

Posits can be highly variable in precision and accuracy based on the total quantity of bits and/or the quantity of sets of integers or sets of bits included in the posit. In addition, posits can generate a wide dynamic range. The accuracy, precision, and/or the dynamic range of a posit can be greater than that of a float, or other numerical formats, under certain conditions, as described in more detail herein. The variable accuracy, precision, and/or dynamic range of a posit can be manipulated, for example, based on an application in which a posit will be used. In addition, posits can reduce or eliminate the overflow, underflow, NaN, and/or other corner cases that are associated with floats and other numerical formats. Further, the use of posits can allow for a numerical value (e.g., a number) to be represented using fewer bits in comparison to floats or other numerical formats.

These features can, in some embodiments, allow for posits to be highly reconfigurable, which can provide improved application performance in comparison to approaches that rely on floats or other numerical formats. In addition, these features of posits can provide improved performance in machine learning applications in comparison to floats or other numerical formats. For example, posits can be used in machine learning applications, in which computational performance is paramount, to train a network (e.g., a neural network) with a same or greater accuracy and/or precision than floats or other numerical formats using fewer bits than floats or other numerical formats. In addition, inference operations in machine learning contexts can be achieved using posits with fewer bits (e.g., a smaller bit width) than floats or other numerical formats. By using fewer bits to achieve a same or enhanced outcome in comparison to floats or other numerical formats, the use of posits can therefore reduce an amount of time in performing operations and/or reduce the amount of memory space required in applications, which can improve the overall function of a computing system in which posits are employed.

Machine Learning applications have become a major user of large computer systems in recent years. Machine Learning algorithms can differ significantly from scientific algorithms. Accordingly, there is reason to believe that some numerical formats, such as the floating-point format, which was created over thirty-five years ago may not be optimal for the new uses. In general, Machine Learning algorithms typically involve approximations dealing with numbers between 0 and 1. As described above, posits are a new numerical format that can provide more precision with the same (or fewer) bits in the range of interest to Machine Learning. The majority of Machine Learning training applications stream though large data sets performing a small number of multiply-accumulate (MAC) operations on each value.

Many hardware vendors and startups have training and inference systems that target fast MAC implementations. These systems tend to be limited not by the number of MACs available, but by the amount of data they can get to the MACs. Posits may have the opportunity to increase performance by allowing shorter floating-point data to be used while increasing the number of operations performed given a fixed memory bandwidth.

Posits may also have the ability to improve the accuracy of repeated MAC operations by eliminating the intermediary rounding by using quire registers to perform the intermediary operations saving the ‘extra’ bits. In some embodiments, only one rounding operation may be required when the eventual answer is saved. Therefore, by correctly sizing the quire register, posits can generate precise results.

One important question with any new numerical format is the difficulty in implementing it. To better understand the implementation difficulties in hardware, some embodiments include implementation of a fully functional posit ALU with multiple quire MACs on a FPGA. In some embodiments, the primary interface to the ALU can be a Basic Linear Algebra Subprogram (BLAS)-like vector interface.

In some approaches, the latency penalty involved using remote FPGA operations instead of local ASIC operations can be significant. In contrast, embodiments herein can include use of a mixed posit environment which can perform scalar posit operations in software while also using the hardware vector posit ALU. This mixed platform can allow for quick porting of applications (e.g., C++ applications) to the hardware platform for testing.

In a non-limiting example using the hardware/software platform, a simple object recognition demo can be ported. In other non-limiting examples, DOE mini-apps can be ported to better understand the porting difficulties and accuracy of existing scientific applications.

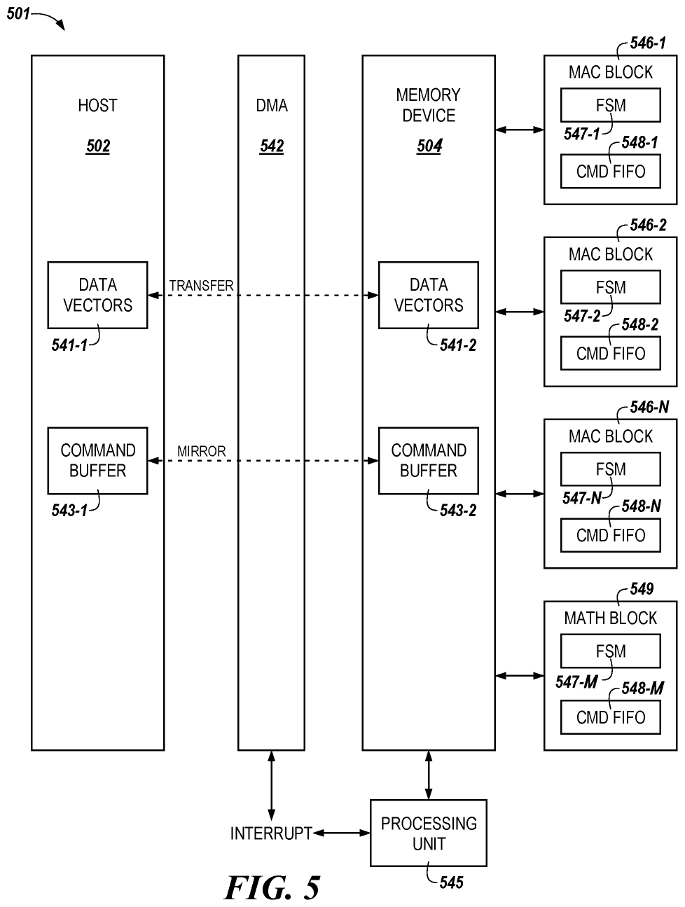

Embodiments herein can include a hardware development system that includes a PCIe pluggable board (e.g., the DMA 542 illustrated in FIG. 5, herein) with a FPGA (e.g., a Xilinx Virtex Ultrascale+(VU9P) FPGA). The FPGA implementation can include a processing device, such as a RISC-V soft-processor, a fully functional 64-bit posit-based ALU, and one or more (e.g., eight) posit MAC modules. The MAC modules (e.g., the MAC blocks 546-1 to 546-N illustrated in FIG. 5) can further include a quire (e.g., the quire 651-1, . . . , 651-N illustrated in FIG. 6, herein), which can be a 512-bit quire. Some embodiments can include one or more memory resources (e.g., one or more random-access memory devices, such as 512 UltraRAM blocks), which can provide local data storage (e.g., 18 MB of local data storage). In some embodiments, a network of AXI busses can provide interconnection between the processing device (e.g. the RISC-V core), the posit-based ALU, the quire-MACs, the memory resource(s), and/or the PCIe interface.

The posit-based ALU (e.g., the ALU 501 illustrated in FIG. 5, herein) can contain pipelined support for the following posit widths: 8-bits, 16-bits, 32-bits, and/or 64-bits, among others, with 0 to 4 bits (among others) used to store the exponent. In some embodiments, the posit-based ALU can perform arithmetic and/or logical operations such as Add, Subtract, Multiply, Divide, Fused Multiply-Add, Absolute Value, Comparison, Exp 2, Log 2, ReLU, and/or the Sigmoid Approximation, among others. In some embodiments, the posit-based ALU can perform operations to convert data between posit formats and floating-point formats, among others.

The posit-based ALU can include a quire which can be limited to 512-bits, however, embodiments are not so limited, and it is contemplated that the quire can be synthesized to support 4K bits in some embodiments (e.g., in embodiments in which the number of quire-MAC modules are reduced). The quire can support pipelined MAC operations, subtraction, shadow quire storage and retrieval, and can convert the quire data to a specified posit format when requested, performing rounding as needed or requested. In some embodiments, the quire width can be parameterized, such that, for smaller FPGAs and/or for applications that do not require support for <64,4> posits, a quire between two and ten times smaller can be synthesized. This is shown below in Table 1.

TABLE I

| Quire | | FPGA |
|---|---|---|
| Width | | LUT |
| (bits) | Posit Shapes | Utilization |
| 4096 | <64,4> | 81K |
| 2048 | <64,3>, <32,4> | 40K |
| 1024 | <64,2>, <64,1>, <32,3>, <16,4> | 15K |
| 512 | <64,0>, <32,2>, <32,1>, <16,3>, <8,4> | 8K |

In some embodiments, (e.g., for fast processing of operands in hardware), data (e.g., the data vectors 541-1 illustrated in FIG. 5, herein) can be written by the host software into memory resources (e.g., random-access memory, such as UltraRAM) associated with the FPGA in the form of vectors. These data vectors can be read by one or more finite state machines (FSMs) using a streaming interface such as an AXI4 streaming interface. The operands in the data vectors can then be presented to the ALU or quire MACs in a pipelined fashion, and after a fixed latency, the output can be retrieved and then stored back to the memory resources at a specified memory address.

TABLE 2

| | CLB |
|---|---|
| IP Module | LUT's |
| ALU (Complete) | 76173 |
| P_ADD & P_SUB | 3990 |
| P_MUL | 2988 |
| P_DIV | 5856 |
| P_DOT | 16289 |
| P_EXP2 | 3189 |
| P_FMA | 5302 |
| P_LOG2 | 15769 |
| P_MAC | 7032 |
| P_ABS | 240 |
| P_COMP | 183 |
| P_F2P | 948 |
| P_P2F | 1201 |
| P_ReLu | 125 |
| P_SIGM | 311 |
| P_Q_MAC | 7133 |
| ADDITIONAL | 5617 |
| LOGIC | |

Table 2 shows various modules described herein with example configurable logic block (CLB) look up tables (LUTs). In some embodiments, finite state machines (FSMs) can be wrapped around the posit-based ALU and each quire-MAC. These FSMs can interface directly with the processing device (e.g., the processing unit 545 illustrated in FIG. 5, which can be a RISC-V processing unit) and/or the memory resources. The FSMs can receive commands from the processing device that can include requests for performance of various math operations to execute in the ALU or MAC and/or commands that can specify addresses in the memory resource(s) from where the operand vectors can be retrieved and then stored after an operation has been completed.

Table 3 shows an example of resource utilization for a posit-based ALU.

TABLE 3

| | FPGA Resource Utilization | | |
|---|---|---|---|
| Posit IP Module | CLB LUTs | Registers | DSPs |
| FULL ALU | 145427 | 58666 | 1392 |
| P_ADD & P_SUB | 3990 | 1998 | 0 |
| P_MUL | 2988 | 1375 | 16 |
| P_DIV | 5856 | 1964 | 208 |
| P_DOT | 16289 | 7810 | 16 |
| P_EXP2 | 3189 | 1046 | 112 |
| P_FMA | 5302 | 1470 | 16 |
| P_LOG2 | 15769 | 907 | 1008 |
| P_MAC | 7032 | 3335 | 16 |
| P_ABS | 240 | 201 | 0 |
| P_COMP | 183 | 136 | 0 |
| P_F2P | 948 | 454 | 0 |
| P_P2F | 1201 | 269 | 0 |
| P_RELU | 125 | 129 | 0 |
| P_SIGM | 311 | 266 | 0 |
| P_QUIRE (4 Kb) | 81656 | 35816 | 0 |
| QUIRE_MAC (512 b) | 7133 | 3545 | 1 |

In some embodiments, a posit-based Basic Linear Algebra Subprogram (BLAS) can provide an abstraction layer between host software and a device (e.g., a posit-based ALU, processing device, quire-MAC, etc.). The posit-BLAS can expose an Application Programming Interface (API) that can be similar to a software BLAS library for operations (e.g., calculations) involving posit vectors. Non-limiting examples of such operations can include routines for calculating dot product, matrix vector product, and/or general matrix by matrix multiplication. In some embodiments, support can be provided for particular activation functions such as ReLu and/or Sigmoid, among others, which can be relevant to machine learning applications. In some embodiments, the library (e.g., the posit-based BLAS library) can be composed of two layers, which can operate on opposite sides of a bus (e.g., a PCI-E bus). On the device side, instructions executed by the processing device (e.g., the RISC-V device) can directly control registers associated with the FPGA. On the host side, library functions (e.g., C library functions, etc.) can be executed to move posit vectors to and from the device via direct memory access (DMA) and/or to communicate commands to the processing device. In some embodiments, these functions can be wrapped with a memory manager and a template library (e.g., a C++ template library) that can allow for software and hardware posits to be mixed in computational pipelines. In some embodiments, the effect of the use of posits on both machine learning and scientific applications can be tested by porting applications to the posit FPGA.

To test posits and machine learning applications, a simple machine learning application can be used. The application can perform simultaneous object recognition in both the posit format and IEEE float format. The application can include multiple instances of fast decomposition MobileNet trained using an ImageNet Large Scale Visual Recognition Competition (ILSVRC) 2012 dataset to identify objects. As used herein, “MobileNet” generally refers to a lightweight convolutional deep learning network architecture. In some embodiments, a variant composed of 383,160 parameters can be selected. The MobileNet can be re-trained on a subset of the ILSVRC dataset to improve accuracy. In a non-limiting example, real time HD video can be converted to 224×224×3 frames and fed into both networks simultaneously at 1.2 frames per second. Inference can be performed on a posit network and an IEEE float32 network. The results can be then compared and output to a video stream. Both networks can be parameterized thereby allowing for a comparison of posit types against IEEE Float32, Bfloat16, and/or Float16. In some embodiments, posits <16,1> can exhibit a slightly higher confidence than 32-bit IEEE (e.g., 97.49% to 97.44%).

The foregoing non-limiting example demonstrates that a non-trivial deep learning network performing inference with posits in the <16,1> bit mode can be utilized to identify a set of objects with accuracy identical to that same network performing inference using IEEE float 32. As described above, the present disclosure can allow for an application that combines hardware and software posit abstractions to guarantee that IEEE float 32 is not used at any step in the calculation, with the majority of the computation performed on the posit processing unit (e.g. the posit-based ALU discussed in connection with FIGS. 5 and 6, herein). That is, in some embodiments, all batch normalization, activation functions, and matrix multiplications can be performed using hardware.

In some embodiments, the posit BLAS library can be written in C++. In contrast, most vanilla ‘C’ applications require recompilation and minor edits to ensure correct linkage. In some approaches, scientific applications can use floats and doubles as parameters and automatic variables. In contrast, embodiments herein can allow for definition of a typedef to replace these two scalars throughout each application. A makefile define can then allow for quick changes between IEEE or various posit types.

In some embodiments, special care can be taken with respect to most convergent algorithms. Posits (particularly when using the quire) can include a greater quantity of bits of significance and/or can converge differently (in particular epsilon is computed differently). For this reason, post- and pre-incrementing of posit numbers may not have the expected result.

In a non-limiting example, a High-Performance Conjugate Gradient (HPCG) Mantevo mini-app can attempt to understand the memory access patterns of several important applications. It may only require typedefs to replace IEEE double with Posit types. In some examples, specifically examples in which the exponent is set at 2, posits may fail to converge. However, using Posit <32,2> can closely resembled IEEE float and Posit <64,4> matched IEEE double.

Algebraic Multi-Grid (AMG) is a DOE mini-app from LLNL. AMG can require a number of explicit C type conversions for C++ conversion. In a non-limiting example, 64-bit Posits computed residual can match IEEE double. 32-bit posit with 4-bit exponent matched IEEE for 8 iterations (residual ˜10\hat{ }−5). In some embodiments, increasing the mantissa 2-bits by going to <32,2> can improve the result (e.g., matched for one more iteration and the residual about ½ order of magnitude lower).

MiniMD is a molecular dynamics mini-app from the Mantevo test suite. In some embodiments, changes made to the mini-app can include changes required because posit_t is not recognized as a primitive type by MPI (common throughout ports) and dumping intermediate values for comparison. 32-bit and 64-bit posits can closely match IEEE double precision bit strings. However, 16-bit posit can differ from IEEE double in this application.

MiniFe is a sparse matrix Mantevo mini-app that uses mostly scalar (software) posits. In a non-limiting example, a small matrix size of 1331 rows can be used to reduce execution time. In this example, posit <32,2> and <64,2> both can reach the computed solution as IEEE double in ⅔ the iterations (with larger residuals).

Synthetic Aperture Radar (SAR) from the Prefect test suite can also need to be converted from C to C++. In a non-limiting example, an input file can be a 2-D float array. In this example, converting to posits can save the array in memory, thereby making conversion to posits easier but possibly increasing the memory footprint.

BackPropagation for 32-bit posits can be compromised by a lack of mantissa bits and posit incrementing by the smallest representable value. Both interpret steps can be slightly improved by the inclusion of additional mantissa bits in a 64-bit posit.

XSBench is a Monte Carlo neutron transport mini-app from Argonne National Lab. In a non-limiting example, it can be ported from C to C++ and typedefs can be added. In this example, there may be few opportunities to use the vector hardware posit unit, which can increase reliance on the software posit implementation. In some embodiments, the mini-app can reset when any element exceeds 1.0. This can occur on one or more iterations different between posit and IEEE (e.g., the posit value can be 0.0004 larger). Overall, in this example, the results appear valid but different. In this example, comparing posit and IEEE results can require significant numerical analysis to understand whether the difference is significant.

To better understand the possible practical impact of the posit floating-point standard, a full posit ALU is described herein. The posit ALU can be small (e.g., ˜76K) and simple to design even with a full-sized quire. In some embodiments, the posit ALU can support 17 different functions allowing it use for many applications, although embodiments are not so limited.

In some embodiments, when posits are used in a simple machine learning application, the 16-bit results can be as accurate as IEEE 32-bit floats. This may allow for double the performance for any memory-bound problem.

In embodiments in which HPC mini-apps are ported to posits, the benefits may be much more nebulous. Basic porting can be straightforward, and equal length Posits can perform very close or better than IEEE floats. However, algorithms that converge on a solution may require careful numerical analyst attention to determine if the solution is correct.

In embodiments that include small standalone machine learning and interference applications, posits can support devices up to 2× faster, and hence, can be more energy efficient than the current IEEE standard.

Embodiments herein are directed to hardware circuitry (e.g., logic circuitry and/or control circuitry) configured to perform various operations using posit bit strings to improve the overall functioning of a computing device. For example, embodiments herein are directed to hardware circuitry that is configured to perform the operations described herein.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

As used herein, designators such as “N” and “M,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more memory banks, whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “bit strings,” “data,” and “data values” are used interchangeably herein and can have the same meaning, as appropriate to the context. In addition, the terms “set of bits,” “bit sub-set,” and “portion” (in the context of a portion of bits of a bit string) are used interchangeably herein and can have the same meaning, as appropriate to the context.

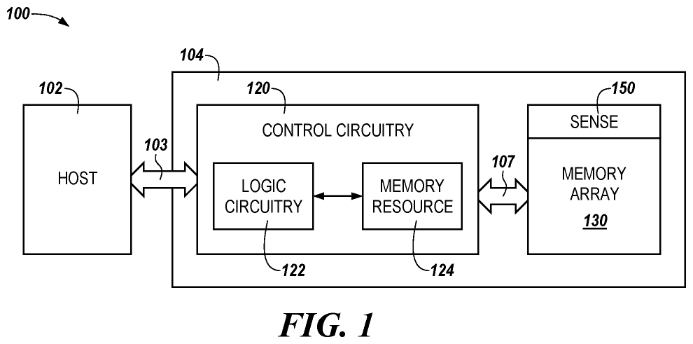

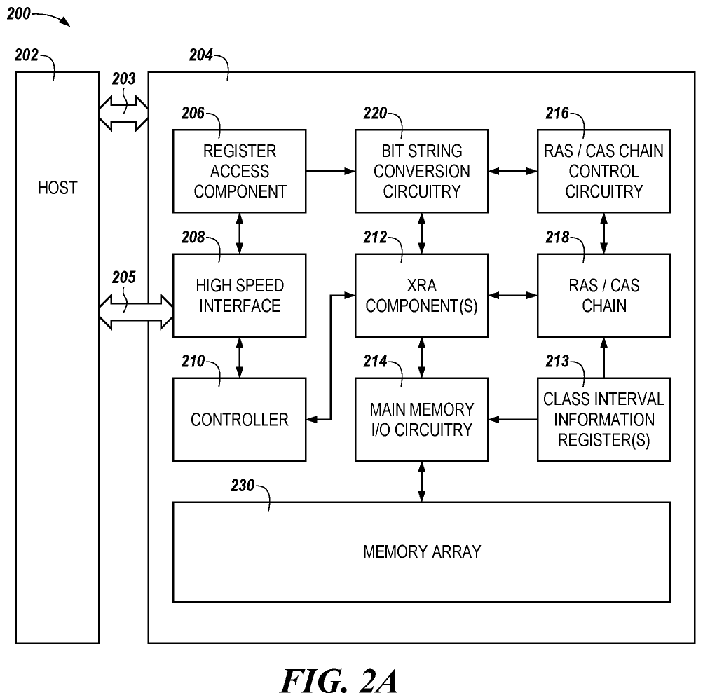

The figures herein follow a numbering convention in which the first digit or digits correspond to the figure number and the remaining digits identify an element or component in the figure. Similar elements or components between different figures may be identified by the use of similar digits. For example, 120 may reference element “20” in FIG. 1, and a similar element may be referenced as 220 in FIG. 2. A group or plurality of similar elements or components may generally be referred to herein with a single element number. For example, a plurality of reference elements 546-1, 546-2, . . . , 546-N may be referred to generally as 546. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram in the form of a computing system 100 including an apparatus including a host 102 and a memory device 104 in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. The memory device 104 can include a one or more memory modules (e.g., single in-line memory modules, dual in-line memory modules, etc.). The memory device 104 can include volatile memory and/or non-volatile memory. In a number of embodiments, memory device 104 can include a multi-chip device. A multi-chip device can include a number of different memory types and/or memory modules. For example, a memory system can include non-volatile or volatile memory on any type of a module. As shown in FIG. 1, the apparatus 100 can include control circuitry 120, which can include logic circuitry 122 and a memory resource 124, a memory array 130, and sensing circuitry 150 (e.g., the SENSE 150). In addition, each of the components (e.g., the host 102, the control circuitry 120, the logic circuitry 122, the memory resource 124, the memory array 130, and/or the sensing circuitry 150) can be separately referred to herein as an “apparatus.” The control circuitry 120 may be referred to as a “processing device” or “processing unit” herein.

The memory device 104 can provide main memory for the computing system 100 or could be used as additional memory or storage throughout the computing system 100. The memory device 104 can include one or more memory arrays 130 (e.g., arrays of memory cells), which can include volatile and/or non-volatile memory cells. The memory array 130 can be a flash array with a NAND architecture, for example. Embodiments are not limited to a particular type of memory device. For instance, the memory device 104 can include RAM, ROM, DRAM, SDRAM, PCRAM, RRAM, and flash memory, among others.

In embodiments in which the memory device 104 includes non-volatile memory, the memory device 104 can include flash memory devices such as NAND or NOR flash memory devices. Embodiments are not so limited, however, and the memory device 104 can include other non-volatile memory devices such as non-volatile random-access memory devices (e.g., NVRAM, ReRAM, FeRAM, MRAM, PCM), “emerging” memory devices such as resistance variable (e.g., 3-D Crosspoint (3D XP)) memory devices, memory devices that include an array of self-selecting memory (SSM) cells, etc., or combinations thereof. Resistance variable memory devices can perform bit storage based on a change of bulk resistance, in conjunction with a stackable cross-gridded data access array. Additionally, in contrast to many flash-based memories, resistance variable non-volatile memory can perform a write in-place operation, where a non-volatile memory cell can be programmed without the non-volatile memory cell being previously erased. In contrast to flash-based memories and resistance variable memories, self-selecting memory cells can include memory cells that have a single chalcogenide material that serves as both the switch and storage element for the memory cell.

As illustrated in FIG. 1, a host 102 can be coupled to the memory device 104. In a number of embodiments, the memory device 104 can be coupled to the host 102 via one or more channels (e.g., channel 103). In FIG. 1, the memory device 104 is coupled to the host 102 via channel 103 and acceleration circuitry 120 of the memory device 104 is coupled to the memory array 130 via a channel 107. The host 102 can be a host system such as a personal laptop computer, a desktop computer, a digital camera, a smart phone, a memory card reader, and/or an internet-of-things (IoT) enabled device, among various other types of hosts.

The host 102 can include a system motherboard and/or backplane and can include a memory access device, e.g., a processor (or processing device). One of ordinary skill in the art will appreciate that “a processor” can intend one or more processors, such as a parallel processing system, a number of coprocessors, etc. The system 100 can include separate integrated circuits or both the host 102, the memory device 104, and the memory array 130 can be on the same integrated circuit. The system 100 can be, for instance, a server system and/or a high-performance computing (HPC) system and/or a portion thereof. Although the example shown in FIG. 1 illustrate a system having a Von Neumann architecture, embodiments of the present disclosure can be implemented in non-Von Neumann architectures, which may not include one or more components (e.g., CPU, ALU, etc.) often associated with a Von Neumann architecture

The memory device 104, which is shown in more detail in FIG. 2, herein, can include acceleration circuitry 120, which can include logic circuitry 122 and a memory resource 124. The logic circuitry 122 can be provided in the form of an integrated circuit, such as an application-specific integrated circuit (ASIC), field programmable gate array (FPGA), reduced instruction set computing device (RISC), advanced RISC machine, system-on-a-chip, or other combination of hardware and/or circuitry that is configured to perform operations described in more detail, herein. In some embodiments, the logic circuitry 122 can comprise one or more processors (e.g., processing device(s), processing unit(s), etc.)

The logic circuitry 122 can perform operations described herein using bit strings formatted in the unum or posit format. Non-limiting examples of operations that can be performed in connection with embodiments described herein can include arithmetic operations such as addition, subtraction, multiplication, division, fused multiply addition, multiply-accumulate, dot product units, greater than or less than, absolute value (e.g., FABS( )), fast Fourier transforms, inverse fast Fourier transforms, sigmoid function, convolution, square root, exponent, and/or logarithm operations, and/or recursive logical operations such as AND, OR, XOR, NOT, etc., as well as trigonometric operations such as sine, cosine, tangent, etc. using the posit bit strings. As will be appreciated, the foregoing list of operations is not intended to be exhaustive, nor is the foregoing list of operations intended to be limiting, and the logic circuitry 122 may be configured to perform (or cause performance of) other arithmetic and/or logical operations.

The control circuitry 120 can further include a memory resource 124, which can be communicatively coupled to the logic circuitry 122. The memory resource 124 can include volatile memory resource, non-volatile memory resources, or a combination of volatile and non-volatile memory resources. In some embodiments, the memory resource can be a random-access memory (RAM) such as static random-access memory (SRAM). Embodiments are not so limited, however, and the memory resource can be a cache, one or more registers, NVRAM, ReRAM, FeRAM, MRAM, PCM), “emerging” memory devices such as resistance variable memory resources, phase change memory devices, memory devices that include arrays of self-selecting memory cells, etc., or combinations thereof.

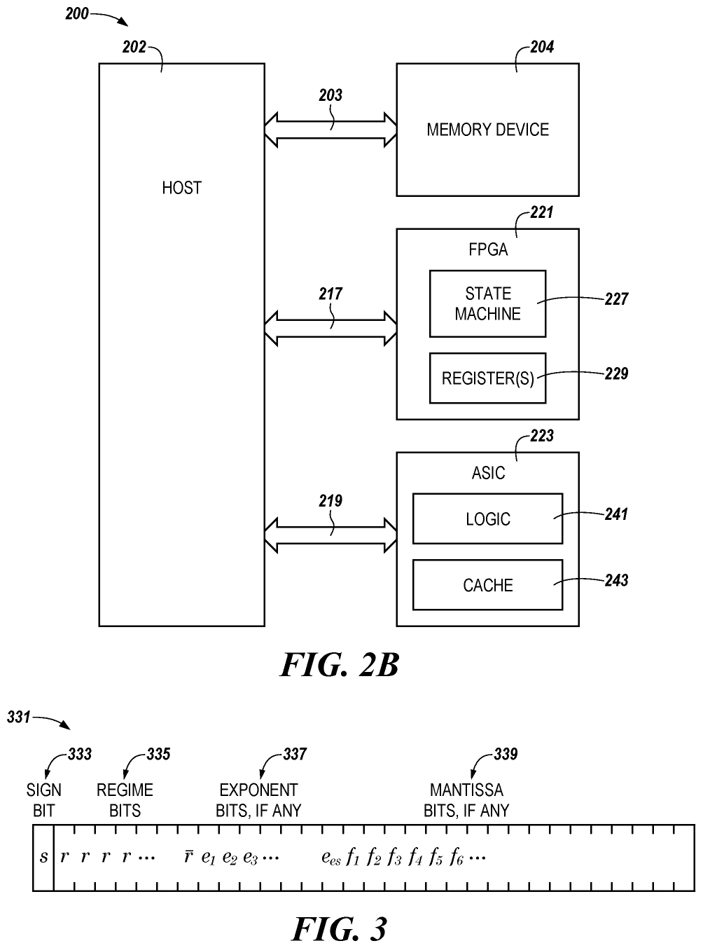

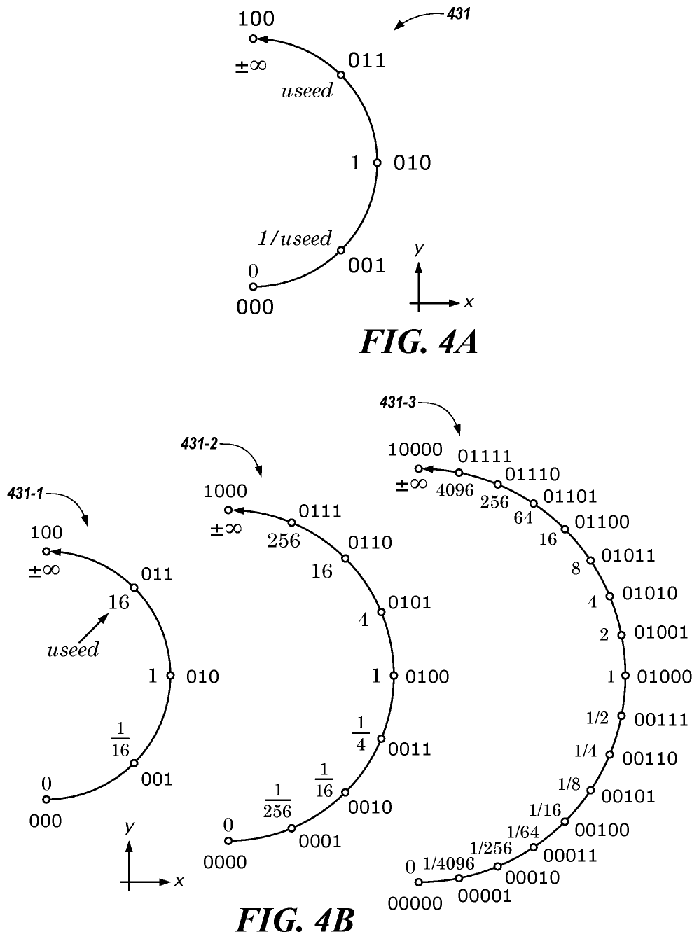

The memory resource 124 can store one or more bit strings. Subsequent to performance of the conversion operation by the logic circuitry 122, the bit string(s) stored by the memory resource 124 can be stored according to a universal number (unum) or posit format. As used herein, the bit string stored in the unum (e.g., a Type III unum) or posit format can include several sub-sets of bits or “bit sub-sets.” For example, a universal number or posit bit string can include a bit sub-set referred to as a “sign” or “sign portion,” a bit sub-set referred to as a “regime” or “regime portion,” a bit sub-set referred to as an “exponent” or “exponent portion,” and a bit sub-set referred to as a “mantissa” or “mantissa portion” (or significand). As used herein, a bit sub-set is intended to refer to a sub-set of bits included in a bit string. Examples of the sign, regime, exponent, and mantissa sets of bits are described in more detail in connection with FIGS. 3 and 4A-4B, herein. Embodiments are not so limited, however, and the memory resource can store bit strings in other formats, such as the floating-point format, or other suitable formats.

In some embodiments, the memory resource 124 can receive data comprising a bit string having a first format that provides a first level of precision (e.g., a floating-point bit string). The logic circuitry 122 can receive the data from the memory resource and convert the bit string to a second format that provides a second level of precision that is different from the first level of precision (e.g., a universal number or posit format). The first level of precision can, in some embodiments, be lower than the second level of precision. For example, if the first format is a floating-point format and the second format is a universal number or posit format, the floating-point bit string may provide a lower level of precision under certain conditions than the universal number or posit bit string, as described in more detail in connection with FIGS. 3 and 4A-4B, herein.

The first format can be a floating-point format (e.g., an IEEE 754 format) and the second format can be a universal number (unum) format (e.g., a Type I unum format, a Type II unum format, a Type III unum format, a posit format, a valid format, etc.). As a result, the first format can include a mantissa, a base, and an exponent portion, and the second format can include a mantissa, a sign, a regime, and an exponent portion.

The logic circuitry 122 can be configured to transfer bit strings that are stored in the second format to the memory array 130, which can be configured to cause performance of an arithmetic operation or a logical operation, or both, using the bit string having the second format (e.g., a unum or posit format). In some embodiments, the arithmetic operation and/or the logical operation can be a recursive operation. As used herein, a “recursive operation” generally refers to an operation that is performed a specified quantity of times where a result of a previous iteration of the recursive operation is used an operand for a subsequent iteration of the operation. For example, a recursive multiplication operation can be an operation in which two bit string operands, β and φ are multiplied together and the result of each iteration of the recursive operation is used as a bit string operand for a subsequent iteration. Stated alternatively, a recursive operation can refer to an operation in which a first iteration of the recursive operation includes multiplying β and φ together to arrive at a result λ (e.g., β×φ=λ). The next iteration of this example recursive operation can include multiplying the result λ by φ to arrive at another result ω (e.g., λ×φ=ω).

Another illustrative example of a recursive operation can be explained in terms of calculating the factorial of a natural number. This example, which is given by Equation 1 can include performing recursive operations when the factorial of a given number, n, is greater than zero and returning unity if the number n is equal to zero:

$$fact ( n ) = \{ \begin{matrix}1 & if n = 0 \\ n \times fact ( n - 1 ) & if n > 0\end{matrix} \qquad Equation 1$$

As shown in Equation 1, a recursive operation to determine the factorial of the number n can be carried out until n is equal to zero, at which point the solution is reached and the recursive operation is terminated. For example, using Equation 1, the factorial of the number n can be calculated recursively by performing the following operations: n×(n−1)×(n−2)× . . . ×1.

Yet another example of a recursive operation is a multiply-accumulate operation in which an accumulator, a is modified at iteration according to the equation a←a+(b×c). In a multiply-accumulate operation, each previous iteration of the accumulator a is summed with the multiplicative product of two operands b and c. In some approaches, multiply-accumulate operations may be performed with one or more roundings (e.g., a may be truncated at one or more iterations of the operation). However, in contrast, embodiments herein can allow for a multiply-accumulate operation to be performed without rounding the result of intermediate iterations of the operation, thereby preserving the accuracy of each iteration until the final result of the multiply-accumulate operation is completed.

Examples of recursive operations contemplated herein are not limited to these examples. To the contrary, the above examples of recursive operations are merely illustrative and are provided to clarify the scope of the term “recursive operation” in the context of the disclosure.

As shown in FIG. 1, sensing circuitry 150 is coupled to a memory array 130 and the control circuitry 120. The sensing circuitry 150 can include one or more sense amplifiers and one or more compute components. The sensing circuitry 150 can provide additional storage space for the memory array 130 and can sense (e.g., read, store, cache) data values that are present in the memory device 104. In some embodiments, the sensing circuitry 150 can be located in a periphery area of the memory device 104. For example, the sensing circuitry 150 can be located in an area of the memory device 104 that is physically distinct from the memory array 130. The sensing circuitry 150 can include sense amplifiers, latches, flip-flops, etc. that can be configured to stored data values, as described herein. In some embodiments, the sensing circuitry 150 can be provided in the form of a register or series of registers and can include a same quantity of storage locations (e.g., sense amplifiers, latches, etc.) as there are rows or columns of the memory array 130. For example, if the memory array 130 contains around 16K rows or columns, the sensing circuitry 150 can include around 16K storage locations.

The embodiment of FIG. 1 can include additional circuitry that is not illustrated so as not to obscure embodiments of the present disclosure. For example, the memory device 104 can include address circuitry to latch address signals provided over I/O connections through I/O circuitry. Address signals can be received and decoded by a row decoder and a column decoder to access the memory device 104 and/or the memory array 130. It will be appreciated by those skilled in the art that the number of address input connections can depend on the density and architecture of the memory device 104 and/or the memory array 130.

FIG. 2A is a functional block diagram in the form of a computing system including an apparatus 200 including a host 202 and a memory device 204 in accordance with a number of embodiments of the present disclosure. The memory device 204 can include control circuitry 220, which can be analogous to the control circuitry 220 illustrated in FIG. 2A. Similarly, the host 202 can be analogous to the host 202 illustrated in FIG. 2A, and the memory device 204 can be analogous to the memory device 204 illustrated in FIG. 2A. Each of the components (e.g., the host 202, the control circuitry 220, the logic circuitry 222, the memory resource 224, and/or the memory array 230, etc.) can be separately referred to herein as an “apparatus.”

The host 202 can be communicatively coupled to the memory device 204 via one or more channels 203, 205. The channels 203, 205 can be interfaces or other physical connections that allow for data and/or commands to be transferred between the host 202 and the memory device 205.

As shown in FIG. 2A, the memory device 204 can include a register access component 206, a high speed interface (HSI) 208, a controller 210, one or more extended row address (XRA) component(s) 212, main memory input/output (I/O) circuitry 214, row address strobe (RAS)/column address strobe (CAS) chain control circuitry 216, a RAS/CAS chain component 218, control circuitry 220, class interval information register(s) 213, and a memory array 230. The control circuitry 220 is, as shown in FIG. 2, located in an area of the memory device 204 that is physically distinct from the memory array 230. That is, in some embodiments, the control circuitry 220 is located in a periphery location of the memory array 230.

The register access component 206 can facilitate transferring and fetching of data from the host 202 to the memory device 204 and from the memory device 204 to the host 202. For example, the register access component 206 can store addresses (or facilitate lookup of addresses), such as memory addresses, that correspond to data that is to be transferred to the host 202 from the memory device 204 or transferred from the host 202 to the memory device 204. In some embodiments, the register access component 206 can facilitate transferring and fetching data that is to be operated upon by the control circuitry 220 and/or the register access component 206 can facilitate transferring and fetching data that is has been operated upon by the control circuitry 220 for transfer to the host 202.

The HSI 208 can provide an interface between the host 202 and the memory device 204 for commands and/or data traversing the channel 205. The HSI 208 can be a double data rate (DDR) interface such as a DDR3, DDR4, DDR5, etc. interface. Embodiments are not limited to a DDR interface, however, and the HSI 208 can be a quad data rate (QDR) interface, peripheral component interconnect (PCI) interface (e.g., a peripheral component interconnect express (PCIe)) interface, or other suitable interface for transferring commands and/or data between the host 202 and the memory device 204.

The controller 210 can be responsible for executing instructions from the host 202 and accessing the control circuitry 220 and/or the memory array 230. The controller 210 can be a state machine, a sequencer, or some other type of controller. The controller 210 can receive commands from the host 202 (via the HSI 208, for example) and, based on the received commands, control operation of the control circuitry 220 and/or the memory array 230. In some embodiments, the controller 210 can receive a command from the host 202 to cause performance of an operation using the control circuitry 220. Responsive to receipt of such a command, the controller 210 can instruct the control circuitry 220 to begin performance of the operation(s).

In some embodiments, the controller 210 can be a global processing controller and may provide power management functions to the memory device 204. Power management functions can include control over power consumed by the memory device 204 and/or the memory array 230. For example, the controller 210 can control power provided to various banks of the memory array 230 to control which banks of the memory array 230 are operational at different times during operation of the memory device 204. This can include shutting certain banks of the memory array 230 down while providing power to other banks of the memory array 230 to optimize power consumption of the memory device 230. In some embodiments, the controller 210 controlling power consumption of the memory device 204 can include controlling power to various cores of the memory device 204 and/or to the control circuitry 220, the memory array 230, etc.

The XRA component(s) 212 are intended to provide additional functionalities (e.g., peripheral amplifiers) that sense (e.g., read, store, cache) data values of memory cells in the memory array 230 and that are distinct from the memory array 230. The XRA components 212 can include latches and/or registers. For example, additional latches can be included in the XRA component 212. The latches of the XRA component 212 can be located on a periphery of the memory array 230 (e.g., on a periphery of one or more banks of memory cells) of the memory device 204.

The main memory input/output (I/O) circuitry 214 can facilitate transfer of data and/or commands to and from the memory array 230. For example, the main memory I/O circuitry 214 can facilitate transfer of bit strings, data, and/or commands from the host 202 and/or the control circuitry 220 to and from the memory array 230. In some embodiments, the main memory I/O circuitry 214 can include one or more direct memory access (DMA) components that can transfer the bit strings (e.g., posit bit strings stored as blocks of data) from the control circuitry 220 to the memory array 230, and vice versa.

In some embodiments, the main memory I/O circuitry 214 can facilitate transfer of bit strings, data, and/or commands from the memory array 230 to the control circuitry 220 so that the control circuitry 220 can perform operations on the bit strings. Similarly, the main memory I/O circuitry 214 can facilitate transfer of bit strings that have had one or more operations performed on them by the control circuitry 220 to the memory array 230. As described in more detail herein, the operations can include operations to vary a numerical value and/or a quantity of bits of the bit string(s) by, for example, altering a numerical value and/or a quantity of bits of various bit sub-sets associated with the bit string(s). As described above, in some embodiments, the bit string(s) can be formatted as a unum or posit.

The row address strobe (RAS)/column address strobe (CAS) chain control circuitry 216 and the RAS/CAS chain component 218 can be used in conjunction with the memory array 230 to latch a row address and/or a column address to initiate a memory cycle. In some embodiments, the RAS/CAS chain control circuitry 216 and/or the RAS/CAS chain component 218 can resolve row and/or column addresses of the memory array 230 at which read and write operations associated with the memory array 230 are to be initiated or terminated. For example, upon completion of an operation using the control circuitry 220, the RAS/CAS chain control circuitry 216 and/or the RAS/CAS chain component 218 can latch and/or resolve a specific location in the memory array 230 to which the bit strings that have been operated upon by the control circuitry 220 are to be stored. Similarly, the RAS/CAS chain control circuitry 216 and/or the RAS/CAS chain component 218 can latch and/or resolve a specific location in the memory array 230 from which bit strings are to be transferred to the control circuitry 220 prior to the control circuitry 220 performing an operation on the bit string(s).

The class interval information register(s) 213 can include storage locations configured to store class interval information corresponding to bit strings that are operated upon by the control circuitry 220. In some embodiments, the class interval information register(s) 213 can comprise a plurality of statistics bins that encompass a total dynamic range available to the bit string(s). The class interval information register(s) 213 can be divided up in such a way that certain portions of the register(s) (or discrete registers) are allocated to handle particular ranges of the dynamic range of the bit string(s). For example, if there is a single class interval information register 213, a first portion of the class interval information register 213 can be allocated to portions of the bit string that fall within a first portion of the dynamic range of the bit string and an Nth portion of the class interval information register 213 can be allocated to portions of the bit string that fall within an Nth portion of the dynamic range of the bit string. In embodiments in which multiple class interval information registers 213 are provided, each class interval information register can correspond to a particular portion of the dynamic range of the bit string.

In some embodiments, the class interval information register(s) 213 can be configured to monitor k values (described below in connection with FIGS. 3 and 4A-4B) corresponding to a regime bit sub-set of the bit string. These values can then be used to determine a dynamic range for the bit string. If the dynamic range for the bit string is currently larger or smaller than a dynamic range that is useful for a particular application or computation, the control circuitry 220 can perform an “up-conversion” or a “down-conversion” operation to alter the dynamic range of the bit string. In some embodiments, the class interval information register(s) 213 can be configured to store matching positive and negative k vales corresponding to the regime bit sub-set of the bit string within a same portion of the register or within a same class interval information register 213.

The class interval information register(s) 213 can, in some embodiments, store information corresponding to bits of the mantissa bit sub-set of the bit string. The information corresponding to the mantissa bits can be used to determine a level of precision that is useful for a particular application or computation. If altering the level of precision could benefit the application and/or the computation, the control circuitry 220 can perform an “up-conversion” or a “down-conversion” operation to alter the precision of the bit string based on the mantissa bit information stored in the class interval information register(s) 213.

In some embodiments, the class interval information register(s) 213 can store information corresponding to a maximum positive value (e.g., maxpos described in connection with FIGS. 3 and 4A-4B) and/or a minimum positive value (e.g., minpos described in connection with FIGS. 3 and 4A-4B) of the bit string(s). In such embodiments, if the class interval information register(s) 213 that store the maxpos and/or minpos values for the bit string(s) are incremented to a threshold value, it can be determined that the dynamic range and/or the precision of the bit string(s) should be altered and the control circuitry 220 can perform an operation on the bit string(s) to alter the dynamic range and/or precision of the bit string(s).

The control circuitry 220 can include logic circuitry (e.g., the logic circuitry 122 illustrated in FIG. 1) and/or memory resource(s) (e.g., the memory resource 124 illustrated in FIG. 1). Bit strings (e.g., data, a plurality of bits, etc.) can be received by the control circuitry 220 from, for example, the host 202, the memory array 230, and/or an external memory device and stored by the control circuitry 220, for example in the memory resource of the control circuitry 220. The control circuitry (e.g., the logic circuitry 122 of the control circuitry 220) can perform operations (or cause operations to be performed) on the bit string(s) to alter a numerical value and/or quantity of bits contained in the bit string(s) to vary the level of precision associated with the bit string(s). As described above, in some embodiments, the bit string(s) can be formatted in a unum or posit format.

As described in more detail in connection with FIGS. 3 and 4A-4B, universal numbers and posits can provide improved accuracy and may require less storage space (e.g., may contain a smaller number of bits) than corresponding bit strings represented in the floating-point format. For example, a numerical value represented by a floating-point number can be represented by a posit with a smaller bit width than that of the corresponding floating-point number. Accordingly, by varying the precision of a posit bit string to tailor the precision of the posit bit string to the application in which it will be used, performance of the memory device 204 may be improved in comparison to approaches that utilize only floating-point bit strings because subsequent operations (e.g., arithmetic and/or logical operations) may be performed more quickly on the posit bit strings (e.g., because the data in the posit format is smaller and therefore requires less time to perform operations on) and because less memory space is required in the memory device 202 to store the bit strings in the posit format, which can free up additional space in the memory device 202 for other bit strings, data, and/or other operations to be performed.

In some embodiments, the control circuitry 220 can perform (or cause performance of) arithmetic and/or logical operations on the posit bit strings after the precision of the bit string is varied. For example, the control circuitry 220 can be configured to perform (or cause performance of) arithmetic operations such as addition, subtraction, multiplication, division, fused multiply addition, multiply-accumulate, dot product units, greater than or less than, absolute value (e.g., FABS( )), fast Fourier transforms, inverse fast Fourier transforms, sigmoid function, convolution, square root, exponent, and/or logarithm operations, and/or logical operations such as AND, OR, XOR, NOT, etc., as well as trigonometric operations such as sine, cosine, tangent, etc. As will be appreciated, the foregoing list of operations is not intended to be exhaustive, nor is the foregoing list of operations intended to be limiting, and the control circuitry 220 may be configured to perform (or cause performance of) other arithmetic and/or logical operations on posit bit strings.

In some embodiments, the control circuitry 220 may perform the above-listed operations in conjunction with execution of one or more machine learning algorithms. For example, the control circuitry 220 may perform operations related to one or more neural networks. Neural networks may allow for an algorithm to be trained over time to determine an output response based on input signals. For example, over time, a neural network may essentially learn to better maximize the chance of completing a particular goal. This may be advantageous in machine learning applications because the neural network may be trained over time with new data to achieve better maximization of the chance of completing the particular goal. A neural network may be trained over time to improve operation of particular tasks and/or particular goals. However, in some approaches, machine learning (e.g., neural network training) may be processing intensive (e.g., may consume large amounts of computer processing resources) and/or may be time intensive (e.g., may require lengthy calculations that consume multiple cycles to be performed).

In contrast, by performing such operations using the bit conversion string circuitry 220, for example, by performing such operations on bit strings in the posit format, the amount of processing resources and/or the amount of time consumed in performing the operations may be reduced in comparison to approaches in which such operations are performed using bit strings in a floating-point format. Further, by varying the level of precision of the posit bit strings, operations performed by the control circuitry 220 can be tailored to a level of precision desired based on the type of operation the control circuitry 220 is performing.

FIG. 2B is a functional block diagram in the form of a computing system 200 including a host 202, a memory device 204, an application-specific integrated circuit 223, and a field programmable gate array 221 in accordance with a number of embodiments of the present disclosure. Each of the components (e.g., the host 202, the conversion component 211, the memory device 204, the FPGA 221, the ASIC 223, etc.) can be separately referred to herein as an “apparatus.”

As shown in FIG. 2BC, the host 202 can be coupled to the memory device 204 via channel(s) 203, which can be analogous to the channel(s) 203 illustrated in FIG. 2A. The field programmable gate array (FPGA) 221 can be coupled to the host 202 via channel(s) 217 and the application-specific integrated circuit (ASIC) 223 can be coupled to the host 202 via channel(s) 219. In some embodiments, the channel(s) 217 and/or the channel(s) 219 can include a peripheral serial interconnect express (PCIe) interface, however, embodiments are not so limited, and the channel(s) 217 and/or the channel(s) 219 can include other types of interfaces, buses, communication channels, etc. to facilitate transfer of data between the host 202 and the FPGA 221 and/or the ASIC 223.

As described above, circuitry located on the memory device 204 (e.g., the bit conversion circuitry 220 illustrated in FIGS. 2A and 2B) can perform various operations using posit bit strings, as described herein. Embodiments are not so limited, however, and in some embodiments, the operations described herein can be performed by the FPGA 221 and/or the ASIC 223. Subsequent to performing the operation to vary the precision of the posit bit string, the bit string(s) can be transferred to the FPGA 221 and/or to the ASIC 223. Upon receipt of the posit bit strings, the FPGA 221 and/or the ASIC 223 can perform arithmetic and/or logical operations on the received posit bit strings.

As described above, non-limiting examples of arithmetic and/or logical operations that can be performed by the FPGA 221 and/or the ASIC 223 include arithmetic operations such as addition, subtraction, multiplication, division, fused multiply addition, multiply-accumulate, dot product units, greater than or less than, absolute value (e.g., FABS( )), fast Fourier transforms, inverse fast Fourier transforms, sigmoid function, convolution, square root, exponent, and/or logarithm operations, and/or logical operations such as AND, OR, XOR, NOT, etc., as well as trigonometric operations such as sine, cosine, tangent, etc. using the posit bit strings.

The FPGA 221 can include a state machine 227 and/or register(s) 229. The state machine 227 can include one or more processing devices that are configured to perform operations on an input and produce an output. For example, the FPGA 221 can be configured to receive posit bit strings from the host 202 or the memory device 204 and perform the operations described herein.

The register(s) 229 of the FPGA 221 can be configured to buffer and/or store the posit bit strings received form the host 202 prior to the state machine 227 performing an operation on the received posit bit strings. In addition, the register(s) 229 of the FPGA 221 can be configured to buffer and/or store a resultant posit bit string that represents a result of the operation performed on the received posit bit strings prior to transferring the result to circuitry external to the ASIC 233, such as the host 202 or the memory device 204, etc.

The ASIC 223 can include logic 241 and/or a cache 243. The logic 241 can include circuitry configured to perform operations on an input and produce an output. In some embodiments, the ASIC 223 is configured to receive posit bit strings from the host 202 and/or the memory device 204 and perform the operations described herein.

The cache 243 of the ASIC 223 can be configured to buffer and/or store the posit bit strings received form the host 202 prior to the logic 241 performing an operation on the received posit bit strings. In addition, the cache 243 of the ASIC 223 can be configured to buffer and/or store a resultant posit bit string that represents a result of the operation performed on the received posit bit strings prior to transferring the result to circuitry external to the ASIC 233, such as the host 202 or the memory device 204, etc.

Although the FPGA 227 is shown as including a state machine 227 and register(s) 229, in some embodiments, the FPGA 221 can include logic, such as the logic 241, and/or a cache, such as the cache 243 in addition to, or in lieu of, the state machine 227 and/or the register(s) 229. Similarly, the ASIC 223 can, in some embodiments, include a state machine, such as the state machine 227, and/or register(s), such as the register(s) 229 in addition to, or in lieu of, the logic 241 and/or the cache 243.

FIG. 3 is an example of an n-bit universal number, or “unum” with es exponent bits. In the example of FIG. 3, the n-bit unum is a posit bit string 331. As shown in FIG. 3, the n-bit posit 331 can include a set of sign bit(s) (e.g., a first bit sub-set or a sign bit sub-set 333), a set of regime bits (e.g., a second bit sub-set or the regime bit sub-set 335), a set of exponent bits (e.g., a third bit sub-set or an exponent bit sub-set 337), and a set of mantissa bits (e.g., a fourth bit sub-set or a mantissa bit sub-set 339). The mantissa bits 339 can be referred to in the alternative as a “fraction portion” or as “fraction bits,” and can represent a portion of a bit string (e.g., a number) that follows a decimal point.

The sign bit 333 can be zero (0) for positive numbers and one (1) for negative numbers. The regime bits 335 are described in connection with Table 4, below, which shows (binary) bit strings and their related numerical meaning, k. In Table 4, the numerical meaning, k, is determined by the run length of the bit string. The letter x in the binary portion of Table 4 indicates that the bit value is irrelevant for determination of the regime, because the (binary) bit string is terminated in response to successive bit flips or when the end of the bit string is reached. For example, in the (binary) bit string 0010, the bit string terminates in response to a zero flipping to a one and then back to a zero. Accordingly, the last zero is irrelevant with respect to the regime and all that is considered for the regime are the leading identical bits and the first opposite bit that terminates the bit string (if the bit string includes such bits).

TABLE 4

| | | | | | | | | |
|---|---|---|---|---|---|---|---|---|
| Binary | 0000 | 0001 | 001X | 01XX | 10XX | 110X | 1110 | 1111 |
| Numerical (k) | −4 | −3 | −2 | −1 | 0 | 1 | 2 | 3 |

In FIG. 3, the regime bits 335 r correspond to identical bits in the bit string, while the regime bits 335 r̅ correspond to an opposite bit that terminates the bit string. For example, for the numerical k value −2 shown in Table 4, the regime bits r correspond to the first two leading zeros, while the regime bit(s) r̅ correspond to the one. As noted above, the final bit corresponding to the numerical k, which is represented by the X in Table 4 is irrelevant to the regime.

If m corresponds to the number of identical bits in the bit string, if the bits are zero, k=−m. If the bits are one, then k=m−1. This is illustrated in Table 3 where, for example, the (binary) bit string 10XX has a single one and k=m−1=1−1=0. Similarly, the (binary) bit string 0001 includes three zeros so k=−m=−3. The regime can indicate a scale factor of useed^{k}, where useed=2²^{^{es}}. Several example values for used are shown below in Table 5.

TABLE 5

| es | 0 | 1 | 2 | 3 | 4 |
|---|---|---|---|---|---|
| used | 2 | 2² = 4 | 4² = 16 | 16² = 256 | 256² = 65536 |

The exponent bits 337 correspond to an exponent e, as an unsigned number. In contrast to floating-point numbers, the exponent bits 337 described herein may not have a bias associated therewith. As a result, the exponent bits 337 described herein may represent a scaling by a factor of 2^{e}. As shown in FIG. 3, there can be up to es exponent bits (e₁, e₂, e₃, . . . , eₑₛ), depending on how many bits remain to right of the regime bits 335 of the n-bit posit 331. In some embodiments, this can allow for tapered accuracy of the n-bit posit 331 in which numbers which are nearer in magnitude to one have a higher accuracy than numbers which are very large or very small. However, as very large or very small numbers may be utilized less frequent in certain kinds of operations, the tapered accuracy behavior of the n-bit posit 331 shown in FIG. 3 may be desirable in a wide range of situations.

The mantissa bits 339 (or fraction bits) represent any additional bits that may be part of the n-bit posit 331 that lie to the right of the exponent bits 337. Similar to floating-point bit strings, the mantissa bits 339 represent a fraction f, which can be analogous to the fraction 1f where f includes one or more bits to the right of the decimal point following the one. In contrast to floating-point bit strings, however, in the n-bit posit 331 shown in FIG. 3, the “hidden bit” (e.g., the one) may always be one (e.g., unity), whereas floating-point bit strings may include a subnormal number with a “hidden bit” of zero (e.g., Of).

As described herein, alter a numerical value or a quantity of bits of one of more of the sign 333 bit sub-set, the regime 335 bit sub-set, the exponent 337 bit sub-set, or the mantissa 339 bit sub-set can vary the precision of the n-bit posit 331. For example, changing the total number of bits in the n-bit posit 331 can alter the resolution of the n-bit posit bit string 331. That is, an 8-bit posit can be converted to a 16-bit posit by, for example, increasing the numerical values and/or the quantity of bits associated with one or more of the posit bit string's constituent bit sub-sets to increase the resolution of the posit bit string. Conversely, the resolution of a posit bit string can be decreased for example, from a 64-bit resolution to a 32-bit resolution by decreasing the numerical values and/or the quantity of bits associated with one or more of the posit bit string's constituent bit sub-sets.

In some embodiments, altering the numerical value and/or the quantity of bits associated with one or more of the regime 335 bit sub-set, the exponent 337 bit sub-set, and/or the mantissa 339 bit sub-set to vary the precision of the n-bit posit 331 can lead to an alteration to at least one of the other of the regime 335 bit sub-set, the exponent 337 bit sub-set, and/or the mantissa 339 bit sub-set. For example, when altering the precision of the n-bit posit 331 to increase the resolution of the n-bit posit bit string 331 (e.g., when performing an “up-convert” operation to increase the bit width of the n-bit posit bit string 331), the numerical value and/or the quantity of bits associated with one or more of the regime 335 bit sub-set, the exponent 337 bit sub-set, and/or the mantissa 339 bit sub-set may be altered.

In a non-limiting example in which the resolution of the n-bit posit bit string 331 is increased (e.g., the precision of the n-bit posit bit string 331 is varied to increase the bit width of the n-bit posit bit string 331) but the numerical value or the quantity of bits associated with the exponent 337 bit sub-set does not change, the numerical value or the quantity of bits associated with the mantissa 339 bit sub-set may be increased. In at least one embodiment, increasing the numerical value and/or the quantity of bits of the mantissa 339 bit sub-set when the exponent 338 bit sub-set remains unchanged can include adding one or more zero bits to the mantissa 339 bit sub-set.

In another non-limiting example in which the resolution of the n-bit posit bit string 331 is increased (e.g., the precision of the n-bit posit bit string 331 is varied to increase the bit width of the n-bit posit bit string 331) by altering the numerical value and/or the quantity of bits associated with the exponent 337 bit sub-set, the numerical value and/or the quantity of bits associated with the regime 335 bit sub-set and/or the mantissa 339 bit sub-set may be either increased or decreased. For example, if the numerical value and/or the quantity of bits associated with the exponent 337 bit sub-set is increased or decreased, corresponding alterations may be made to the numerical value and/or the quantity of bits associated with the regime 335 bit sub-set and/or the mantissa 339 bit sub-set. In at least one embodiment, increasing or decreasing the numerical value and/or the quantity of bits associated with the regime 335 bit sub-set and/or the mantissa 339 bit sub-set can include adding one or more zero bits to the regime 335 bit sub-set and/or the mantissa 339 bit sub-set and/or truncating the numerical value or the quantity of bits associated with the regime 335 bit sub-set and/or the mantissa 339 bit sub-set.

In another example in which the resolution of the n-bit posit bit string 331 is increased (e.g., the precision of the n-bit posit bit string 331 is varied to increase the bit width of the n-bit posit bit string 331), the numerical value and/or the quantity of bits associated with the exponent 335 bit sub-set may be increased and the numerical value and/or the quantity of bits associated with the regime 333 bit sub-set may be decreased. Conversely, in some embodiments, the numerical value and/or the quantity of bits associated with the exponent 335 bit sub-set may be decreased and the numerical value and/or the quantity of bits associated with the regime 333 bit sub-set may be increased.

In a non-limiting example in which the resolution of the n-bit posit bit string 331 is decreased (e.g., the precision of the n-bit posit bit string 331 is varied to decrease the bit width of the n-bit posit bit string 331) but the numerical value or the quantity of bits associated with the exponent 337 bit sub-set does not change, the numerical value or the quantity of bits associated with the mantissa 339 bit sub-set may be decreased. In at least one embodiment, decreasing the numerical value and/or the quantity of bits of the mantissa 339 bit sub-set when the exponent 338 bit sub-set remains unchanged can include truncating the numerical value and/or the quantity of bits associated with the mantissa 339 bit sub-set.

In another non-limiting example in which the resolution of the n-bit posit bit string 331 is decreased (e.g., the precision of the n-bit posit bit string 331 is varied to decrease the bit width of the n-bit posit bit string 331) by altering the numerical value and/or the quantity of bits associated with the exponent 337 bit sub-set, the numerical value and/or the quantity of bits associated with the regime 335 bit sub-set and/or the mantissa 339 bit sub-set may be either increased or decreased. For example, if the numerical value and/or the quantity of bits associated with the exponent 337 bit sub-set is increased or decreased, corresponding alterations may be made to the numerical value and/or the quantity of bits associated with the regime 335 bit sub-set and/or the mantissa 339 bit sub-set. In at least one embodiment, increasing or decreasing the numerical value and/or the quantity of bits associated with the regime 335 bit sub-set and/or the mantissa 339 bit sub-set can include adding one or more zero bits to the regime 335 bit sub-set and/or the mantissa 339 bit sub-set and/or truncating the numerical value or the quantity of bits associated with the regime 335 bit sub-set and/or the mantissa 339 bit sub-set.

In some embodiments, changing the numerical value and/or a quantity of bits in the exponent bit sub-set can alter the dynamic range of the n-bit posit 331. For example, a 32-bit posit bit string with an exponent bit sub-set having a numerical value of zero (e.g., a 32-bit posit bit string with es=0, or a (32,0) posit bit string) can have a dynamic range of approximately 18 decades. However, a 32-bit posit bit string with an exponent bit sub-set having a numerical value of 3 (e.g., a 32-bit posit bit string with es=3, or a (32,3) posit bit string) can have a dynamic range of approximately 145 decades.

FIG. 4A is an example of positive values for a 3-bit posit. In FIG. 4A, only the right half of projective real numbers, however, it will be appreciated that negative projective real numbers that correspond to their positive counterparts shown in FIG. 4A can exist on a curve representing a transformation about they-axis of the curves shown in FIG. 4A.

In the example of FIG. 4A, es=2, so useed=2²^{^{es}}=16. The precision of a posit 431-1 can be increased by appending bits the bit string, as shown in FIG. 4B. For example, appending a bit with a value of one (1) to bit strings of the posit 431-1 increases the accuracy of the posit 431-1 as shown by the posit 431-2 in FIG. 4B. Similarly, appending a bit with a value of one to bit strings of the posit 431-2 in FIG. 4B increases the accuracy of the posit 431-2 as shown by the posit 431-3 shown in FIG. 4B. An example of interpolation rules that may be used to append bits to the bits strings of the posits 431-1 shown in FIG. 4A to obtain the posits 431-2, 431-3 illustrated in FIG. 4B follow.

If maxpos is the largest positive value of a bit string of the posits 431-1, 431-2, 431-3 and minpos is the smallest value of a bit string of the posits 431-1, 431-2, 431-3, maxpos may be equivalent to useed and minpos may be equivalent to

$$\frac{1}{useed} .$$

Between maxpos and +∞, a new bit value may be maxpos*useed, and between zero and minpos, a new bit value may be

$$\frac{minpos}{useed} .$$

These new bit values can correspond to a new regime bit 335. Between existing values x=2^{m} and y=2ⁿ, where m and n differ by more than one, the new bit value may be given by the geometric mean:

$$\sqrt{x \times y} = 2 \frac{( m + n )}{2} ,$$

which corresponds to a new exponent bit 337. If the new bit value is midway between the existing x and y values next to it, the new bit value can represent the arithmetic mean

$$\frac{x + y}{2} ,$$

which corresponds to a new mantissa bit 339.

FIG. 4B is an example of posit construction using two exponent bits. In FIG. 4B, only the right half of projective real numbers, however, it will be appreciated that negative projective real numbers that correspond to their positive counterparts shown in FIG. 4B can exist on a curve representing a transformation about they-axis of the curves shown in FIG. 4B. The posits 431-1, 431-2, 431-3 shown in FIG. 4B each include only two exception values: Zero (0) when all the bits of the bit string are zero and +∞ when the bit string is a one (1) followed by all zeros. It is noted that the numerical values of the posits 431-1, 431-2, 431-3 shown in FIG. 4 are exactly useed^{k}. That is, the numerical values of the posits 431-1, 431-2, 431-3 shown in FIG. 4 are exactly useed to the power of the k value represented by the regime (e.g., the regime bits 335 described above in connection with FIG. 3). In FIG. 4B, the posit 431-1 has es=2, so useed=2²^{^{es}}=16, the posit 431-2 has es=3, so useed=2²^{^{es}}=256, and the posit 431-3 has es=4, so useed=2²^{^{es}}=4096.

As an illustrative example of adding bits to the 3-bit posit 431-1 to create the 4-bit posit 431-2 of FIG. 4B, the useed=256, so the bit string corresponding to the useed of 256 has an additional regime bit appended thereto and the former useed, 16, has a terminating regime bit (r̅) appended thereto. As described above, between existing values, the corresponding bit strings have an additional exponent bit appended thereto. For example, the numerical values 1/16, ¼, 1, and 4 will have an exponent bit appended thereto. That is, the final one corresponding to the numerical value 4 is an exponent bit, the final zero corresponding to the numerical value 1 is an exponent bit, etc. This pattern can be further seen in the posit 431-3, which is a 5-bit posit generated according to the rules above from the 4-bit posit 431-2. If another bit was added to the posit 431-3 in FIG. 4B to generate a 6-bit posit, mantissa bits 339 would be appended to the numerical values between 1/16 and 16.

A non-limiting example of decoding a posit (e.g., a posit 431) to obtain its numerical equivalent follows. In some embodiments, the bit string corresponding to a posit p is an unsigned integer ranging from −2ⁿ to 2ⁿ⁻¹, k is an integer corresponding to the regime bits 335 and e is an unsigned integer corresponding to the exponent bits 337. If the set of mantissa bits 339 is represented as {f₁ f₂ . . . f_{fs}} and f is a value represented by 1. f₁ f₂ . . . f_{fs} (e.g., by a one followed by a decimal point followed by the mantissa bits 339), the p can be given by Equation 2, below.

$$x = \{ \begin{matrix}0 , & p = 0 \\ \pm ∞ , & p = - {2}^{n - 1} \\ sign ( p ) \times {useed}^{k} \times {2}^{e} \times f , & all other p\end{matrix} \qquad Equation 2$$

A further illustrative example of decoding a posit bit string is provided below in connection with the posit bit string 0000110111011101 shown in Table 6, below follows.

TABLE 6

| SIGN | REGIME | EXPONENT | MANTISSA |
|---|---|---|---|
| 0 | 0001 | 101 | 11011101 |

In Table 6, the posit bit string 0000110111011101 is broken up into its constituent sets of bits (e.g., the sign bit 333, the regime bits 335, the exponent bits 337, and the mantissa bits 339). Since es=3 in the posit bit string shown in Table 3 (e.g., because there are three exponent bits), useed=256. Because the sign bit 333 is zero, the value of the numerical expression corresponding to the posit bit string shown in Table 6 is positive. The regime bits 335 have a run of three consecutive zeros corresponding to a value of −3 (as described above in connection with Table 1). As a result, the scale factor contributed by the regime bits 335 is 256⁻³ (e.g., useed^{k}). The exponent bits 337 represent five (5) as an unsigned integer and therefore contribute an additional scale factor of 2^{e}=2⁵=32. Lastly, the mantissa bits 339, which are given in Table 4 as 11011101, represent two-hundred and twenty-one (221) as an unsigned integer, so the mantissa bits 339, given above as f are f+221/256. Using these values and Equation 1, the numerical value corresponding to the posit bit string given in Table 4 is +256⁻³×2⁵×(1+221/256)=437/134217728≈3.55393×10⁻⁶.

FIG. 5 is a functional block diagram in the form of a computing system 501 that can include a portion of an arithmetic logic unit in accordance with a number of embodiments of the present disclosure. The quire (e.g., 651-1, . . . , 651-N illustrated in FIG. 6, herein) can support pipelined MAC operations, multiply-subtraction, shadow quire storage and retrieval and converts the quire data to a specified posit format when requested, performing rounding as needed. In some embodiments, the pipelined quire-MAC modules can reduce the quire functionality such that the shadow quire is not included, and Multiply-Subtraction cannot be performed. The example of FIG. 5 may allow for reduced quire functionality such that the shadow quire is not included and/or such that a multiply-subtraction operation may not be able to be performed, although embodiments are not so limited and embodiments in which full quire functionality is provided are contemplated within the scope of the disclosure.

As shown in FIG. 5, the computing system 501 can include a host 502, a direct media access (DMA) 542 component, a memory device 504, multiply accumulate (MAC) blocks 546-1, . . . , 546-N, and a math block 549. The host 502 can include data vectors 541-1 and a command buffer 543-1. As shown in FIG. 5, the data vectors 541-1 can be transferred to the memory device 504 and can be stored by the memory device 504 as data vectors 541-1. In addition, the memory device 504 can include a command buffer 543-2 that can mirror the command buffer 543-1 of the host 502. In some embodiments, the command buffer 543-2 can include instructions corresponding to a program and/or application to be executed by the MAC blocks 546-1, . . . , 546-N and/or the math block 549.

The MAC block 546-1, . . . , 546-N can include respective finite state machines (FSMs) 547-1, . . . , 547-N and respective command first-in first-out (FIFO) buffers 548-1, . . . , 548-N. The math block 549 can include a finite state machine 547-1 and a command FIFO buffer 548-1. In some embodiments, the memory device 504 is communicatively coupled to a processing unit 545, that be configured to transfer interrupt signals between the DMA 542 and the memory device 504. In some embodiments, the processing unit 545 and the MAC blocks 546-1, . . . , 546-N can form at least a portion of an ALU.

As described herein, the data vectors 541-1 can include bit strings that are formatted according to a posit or universal number format. In some embodiments, the data vectors 541-1 can be converted to a posit format from a different format (e.g., a floating-point format) using circuitry on the host 502 prior to being transferred to the memory device 504. The data vectors 541—can be transferred to the memory device 504 via the DMA 542, which can include various interfaces, such as a PCIe interface or an XDMA interface, among others.

The MAC blocks 546-1, . . . , 546-N can include circuitry, logic, and/or other hardware components to perform various arithmetic and/or logical operations, such as multiply-accumulate operations, using posit or universal number data vectors (e.g., bit strings formatted according to a posit or universal number format). For example, the MAC blocks 546-1, . . . , 546-N can include sufficient processing resources and/or memory resources to perform the various arithmetic and/or logical operations described herein.

In some embodiments, the finite state machines (FSMs) 547-1, . . . , 547-N can perform at least a portion of the various arithmetic and/or logical operations performed by the MAC blocks 546-1, . . . , 546-N. For example, the FSMs 547-1, . . . , 547-N can perform at least a multiply operation in connection with performance of a MAC operation executed by the MAC blocks 546-1, . . . , 546-N.

The MAC blocks 546-1, . . . , 546-N and/or the FSMs 547-1, . . . , 547-N can perform operations described herein in response to signaling (e.g., commands, instructions, etc.) received by, and/or buffered by, the CMD FIFOs 548-1, . . . , 548-N. For example, the CMD FIFOs 548-1, . . . , 548-N can receive and buffer signaling corresponding to instructions and/or commands received from the command buffer 543-1/543-2 and/or the processing unit 545. In some embodiments, the signaling, instructions, and/or commands can include information corresponding to the data vectors 541-1, such as a location in the host 502 and/or memory device 504 in which the data vectors 541-1 are stored; operations to be performed using the data vectors 541-1; optimal bit shapes for the data vectors 541-1; formatting information corresponding to the data vectors 541-1; and/or programming languages associated with the data vectors 541-1, among others.

The math block 549 can include hardware circuitry that can perform various arithmetic operations in response to instructions received from the command buffer 543-2. The arithmetic operations performed by the math block 549 can include addition, subtraction, multiplication, division, square root, modulo, less or greater than operations, sigmoid operations, and/or ReLu, among others. The CMD FIFO 548-M can store a set of instructions that can be executed by the FSM 547-M to cause performance of arithmetic operations using the math block 549. For example, instructions (e.g., commands) can be retrieved by the FSM 547-M from the CMD FIFO 548-M and executed by the FSM 547-M in performance of operations described herein. In some embodiments, the math block 549 can perform the arithmetic operations described above in connection with performance of operations using the MAC blocks 546-1, . . . , 546-N.

In a non-limiting example, the host 502 can be coupled to an arithmetic logic unit that includes a processing device (e.g., the processing unit 545), a quire register (e.g., the quire registers 651-1, . . . , 651-N illustrated in FIG. 6, herein) coupled to the processing device, and a multiply-accumulate (MAC) block (e.g., the MAC blocks 546-1, . . . , 546-N) coupled to the processing device. The ALU can receive one or more vectors (e.g., the data vectors 541-1) that are formatted according to a posit format. The ALU can perform a plurality of operations using at least one of the one or more vectors, store an intermediate result of at least one of the plurality of operations in the quire, and/or output a final result of the operation to the host.

As described above, in some embodiments, the ALU can output the final result of the operation after a fixed predetermined period of time. In addition, as described above, the plurality of operations can be performed as part of a machine learning application, as part of a neural network training application, and/or as part of s scientific application.

Continuing with this example, the ALU can an optimal bit shape for the one or more vectors and/or perform an operation to convert information provided in a first programming language to a second programming language as part of performing the plurality of operations.

FIG. 6 is a functional block diagram in the form of a portion of an arithmetic logic unit in accordance with a number of embodiments of the present disclosure. The portion of the arithmetic logic unit (ALU) depicted in FIG. 6 can correspond to the right-most portion of the computing system 501 illustrated in FIG. 5, herein. For example, as shown in FIG. 6, the portion of the ALU can include MAC blocks 646-1, . . . , 646-N, which can include respective finite state machines 647-1, . . . , 647-N and respective command FIFO buffers 648-1, . . . , 648-N. Each of the MAC blocks 646-1, . . . , 646-N can include a respective quire register 651-1, . . . , 651-N. In the embodiments shown in FIG. 6, the math block 649 can include an arithmetic unit 653.

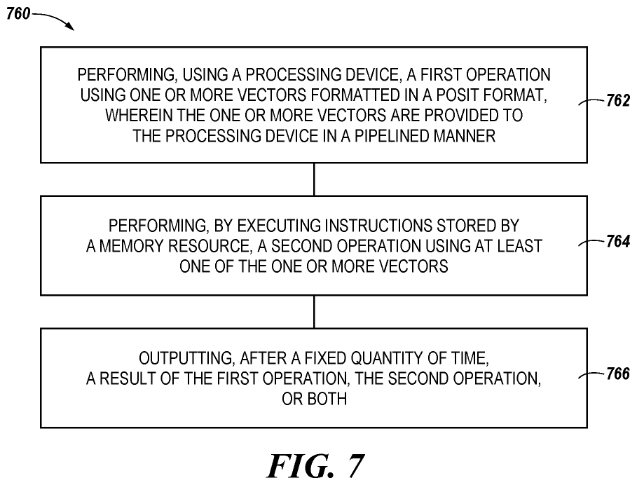

FIG. 7 illustrates an example method 760 for an arithmetic logic unit in accordance with a number of embodiments of the present disclosure. At block 762, the method 760 can include performing, using a processing device, a first operation using one or more vectors (e.g., the data vectors 541-1 illustrated in FIG. 5, herein) formatted in a posit format. The one or more vectors can be provided to the processing device in a pipelined manner.

At block 764, the method 760 can include performing, by executing instructions stored by a memory resource, a second operation using at least one of the one or more vectors. At block 766, the method 760 can include outputting, after a fixed quantity of time, a result of the first operation, the second operation, or both. In some embodiments, by outputting the result after a fixed quantity of time, the result can be provided to circuitry external to the processing device and/or memory device in a deterministic manner. In some embodiments, the first operation and/or the second operation can be performed as part of a machine learning application, a neural network training application, and/or a multiply-accumulate operation.

The method 760 can further include selectively performing the first operation, the second operation, or both based, at least in part on a determined parameter corresponding to respective vectors among the one or more vectors. The method 760 can further include storing an intermediate result of the first operation, the second operation, or both in a quire coupled to the processing device.

In some embodiments, the arithmetic logic circuitry (ALU) can be provided in the form of an apparatus that includes a processing device, a quire coupled to the processing device, and a multiply-accumulate (MAC) block coupled to the processing device. The ALU can be configured to receive one or more vectors formatted according to a posit format, perform a plurality of operations using at least one of the one or more vectors, store an intermediate result of at least one of the plurality of operations in the quire, and/or output a final result of the operation to circuitry external to the ALU. As described above, the ALU can be configured to output the final result of the operation after a fixed predetermined period of time. The plurality of operations can be performed as part of a machine learning application or a as part of a neural network training application, a scientific application, or any combination thereof.

In some embodiments, the one or more vectors can be pipelined to the ALU. The ALU can be configured to perform an operation to convert information provided in a first programming language to a second programming language as part of performing the plurality of operations. In some embodiments, the ALU can be configured to determine an optimal bit shape for the one or more vectors.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
performing, using a processing device, a first operation using one or more vectors formatted in a posit format, wherein the one or more vectors are provided to the processing device in a pipelined manner;
performing, by executing instructions stored by a memory resource, a second operation using at least one of the one or more vectors; and
outputting, after a fixed quantity of time, a result of the first operation, the second operation, or both.

2. The method of claim 1, further comprising selectively performing the first operation, the second operation, or both based, at least in part on a determined parameter corresponding to respective vectors among the one or more vectors.

3. The method of claim 1, further comprising storing an intermediate result of the first operation, the second operation, or both in a quire coupled to the processing device.

4. The method of claim 1, wherein the first operation, the second operation, or both, are performed as part of a machine learning application.

5. The method of claim 1, wherein the first operation, the second operation, or both, are performed as part of a neural network training application.

6. The method of claim 1, wherein the first operation, the second operation, or both, are performed as part of a multiply-accumulate operation.

7. An apparatus, comprising:
an arithmetic logic unit (ALU) comprising:
a processing device;
a quire coupled to the processing device; and
a multiply-accumulate (MAC) block coupled to the processing device, wherein the ALU is configured to:
receive one or more vectors formatted according to a posit format;
perform a plurality of operations using at least one of the one or more vectors;
store an intermediate result of at least one of the plurality of operations in the quire; and
output a final result of the operation to circuitry external to the ALU.

8. The apparatus of claim 7, wherein the ALU is further configured to output the final result of the operation after a fixed predetermined period of time.

9. The apparatus of claim 7, wherein the plurality of operations are performed as part of a machine learning application or a as part of a neural network training application.

10. The apparatus of claim 7, wherein the plurality of operations are performed as part of a scientific application.

11. The apparatus of claim 7, wherein the one or more vectors are pipelined to the ALU.

12. The apparatus of claim 7, wherein the ALU is configured to perform an operation to convert information provided in a first programming language to a second programming language as part of performing the plurality of operations.

13. The apparatus of claim 7, wherein the ALU is configured to determine an optimal bit shape for the one or more vectors.

14. A system, comprising:
a host; and
an arithmetic logic unit (ALU) comprising:
a processing device;
a quire register coupled to the processing device; and
a multiply-accumulate (MAC) block coupled to the processing device, wherein the ALU is configured to:
receive one or more vectors formatted according to a posit format;
perform a plurality of operations using at least one of the one or more vectors;
store an intermediate result of at least one of the plurality of operations in the quire; and
output a final result of the operation to the host.

15. The system of claim 14, wherein the ALU is further configured to output the final result of the operation after a fixed predetermined period of time.

16. The system of claim 14, wherein the plurality of operations are performed as part of a machine learning application or a as part of a neural network training application.

17. The system of claim 14, wherein the plurality of operations are performed as part of a scientific application.

18. The system of claim 14, wherein the one or more vectors are pipelined to the ALU.

19. The system of claim 14, wherein the ALU is configured to perform an operation to convert information provided in a first programming language to a second programming language as part of performing the plurality of operations.

20. The system of claim 14, wherein the ALU is configured to determine an optimal bit shape for the one or more vectors.
